(19) United States
(12) Patent Application Publication
(10) Pub. No.: US 2008/0184562 A1
(43) Pub. Date: Aug. 7, 2008

(54) Electric shaver with nose hair trimmer

(76) Inventors: Ching-Tien Pi, Hsin-Tien City (TW); Chia-Yu Pi, Hsin-Tien City (TW)

Correspondence Address: BRUCE H. TROXELL, SUITE 1404, 5205 LEESBURG PIKE, FALLS CHURCH, VA, 22041, US

(21) Appl. No.: 11/701,546

(22) Filed: Feb. 2, 2007

(51) Int. Cl. B26B 19/00

(52) U.S. Cl. 30/34.1

(57) ABSTRACT

An electric shaver includes a control unit connected to a gear set, so as to drive the gear set to rotate at least one cutter blade set for cutting beard; and a nose hair trimmer, which includes a gear mechanism, a central rotary shaft, a nose hair blade, and an engaging & disengaging element. The gear mechanism includes a gear wheel meshing with the gear set, and an engaging head connected to and rotating along with the gear wheel. The nose hair blade and the engaging & disengaging element are fixedly mounted on the central rotary shaft. When the central rotary shaft is moved forward by a predetermined distance to engage the engaging & disengaging element with the engaging head, the nose hair blade on the central rotary shaft is protruded from the electric shaver while rotating to trim nose hair.

### FIELD OF THE INVENTION

The present invention relates to an electric shaver, and more particularly, to an electric shaver with nose hair trimmer.

### BACKGROUND OF THE INVENTION

FIG. 1 is a perspective view of a conventional electric shaver 90, which generally includes two cutter blade sets, a gear set, a control unit, and a housing that encloses all the above components therein. The gear set includes a driving gear, an idle gear, and two driven gears. The driving gear meshes with the idle gear, and the driven gears mesh with the idle gear and are connected to the cutter blade sets. The control unit includes a power supply device and a motor electrically connected to the power supply device. The motor is connected to the driving gear, so as to drive the gear set to rotate and thereby cause the cutter blade sets to operate and cut beard.

The conventional electric shaver 90 provides only one shaving function to remove beard. When a user wants to trim nose hair, he has to buy an additional nose hair trimmer. It is of course very inconvenient, uneconomical, and inefficient for the user to buy and operate two different devices to complete facial grooming.

### SUMMARY OF THE INVENTION

It is therefore a primary object of the present invention to provide an electric shaver with nose hair trimmer, so that a user needs to manipulate only one device to complete shaving and nose hair trimming in one time.

To achieve the above and other objects, the electric shaver with nose hair trimmer according to the present invention includes a control unit connected to a gear set, so as to drive the gear set to rotate at least one cutter blade set for cutting beard; and a nose hair trimmer, which includes a gear mechanism, a central rotary shaft, a nose hair blade, and an engaging & disengaging element. The gear mechanism includes a gear wheel meshing with the gear set, and an engaging head connected to and rotating along with the gear wheel. The nose hair blade and the engaging & disengaging element are fixedly mounted on the central rotary shaft. When the control unit drives the gear set and accordingly the engaging head to rotate, and the central rotary shaft is moved forward by a predetermined distance to engage the engaging & disengaging element with the engaging head, the central rotary shaft is brought to rotate, and the nose hair blade on the central rotary shaft is protruded from the electric shaver while rotating to trim nose hair.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional electric shaver;

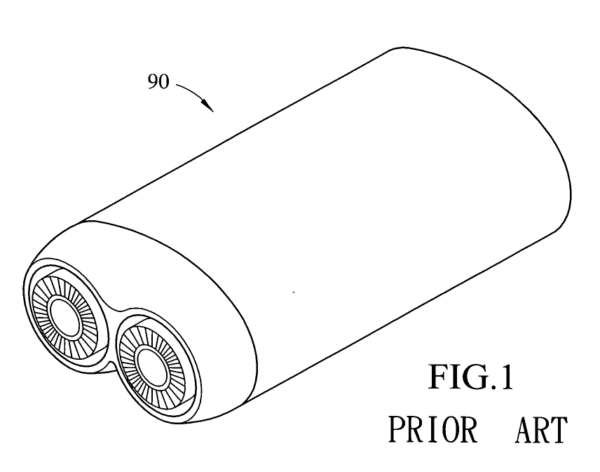

FIG. 2A is a perspective view of an electric shaver with nose hair trimmer according to a first embodiment of the present invention, wherein the nose hair trimmer is in a retracted position;

FIG. 2B is a perspective view of the electric shaver of FIG. 2A with the nose hair trimmer in a protruded position for use;

FIG. 3 is an exploded perspective view of the electric shaver with nose hair trimmer shown in FIG. 2A;

FIG. 4 is a side view of the nose hair trimmer included in the electric shaver of FIG. 2A;

FIG. 5 shows the relative rotational directions of a gear set for the electric shaver and a gear wheel for the nose hair trimmer in the present invention;

FIG. 6 is a side view of the nose hair trimmer of FIG. 4 in a protruded position for trimming nose hair;

FIG. 7 is a partially exploded perspective view of an electric shaver with nose hair trimmer according to a second embodiment of the present invention; and

FIG. 8 is a partially exploded perspective view of an electric shaver with nose hair trimmer according to a third embodiment of the present invention.

### DETAILED DESCRIPTION OF THE PREFERRED EMBODIMENTS

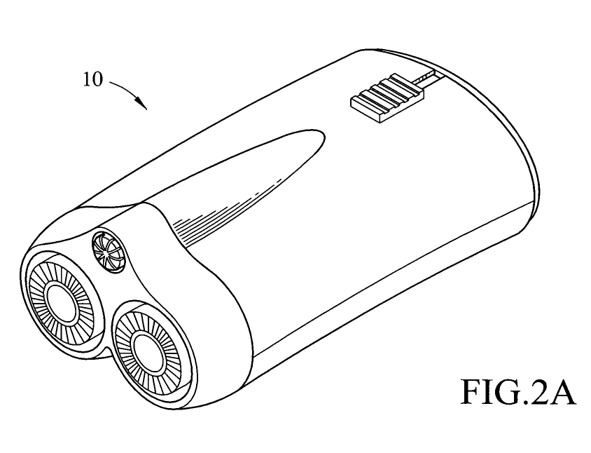

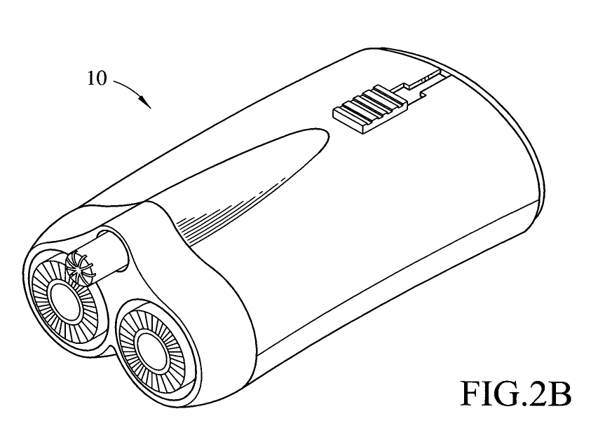

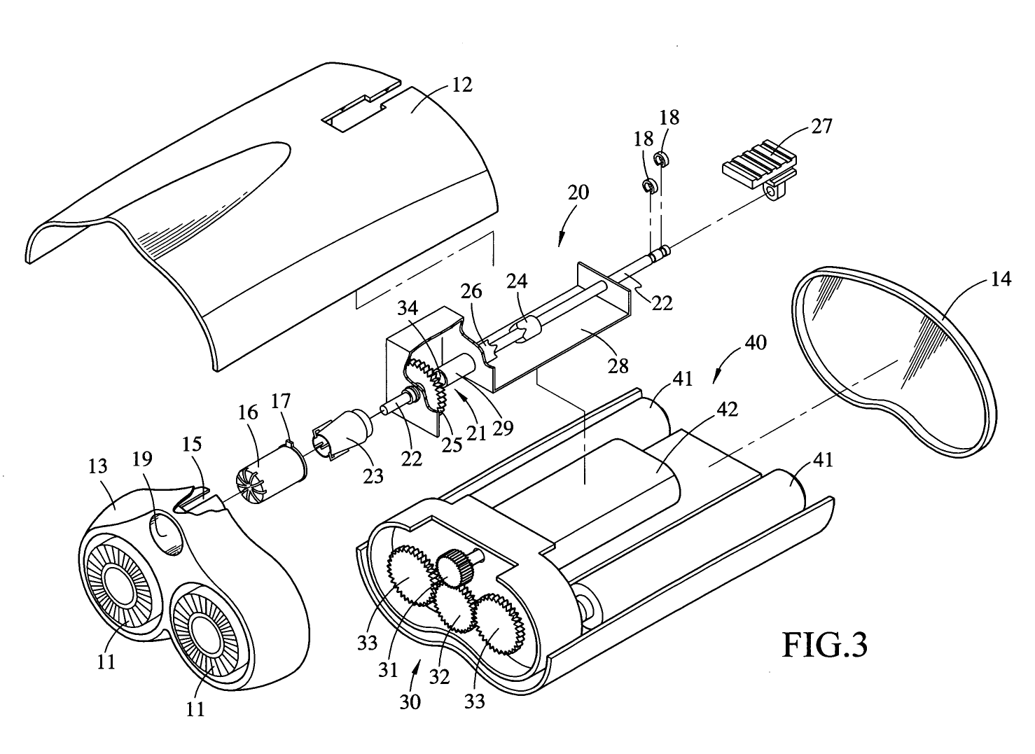

Please refer to FIGS. 2A and 3 that are assembled and exploded perspective views, respectively, of an electric shaver with nose hair trimmer according to a first embodiment of the present invention. As shown, the electric shaver, which is generally denoted by reference numeral 10, includes two cutter blade sets 11, a body case 12, a front cover 13, a rear cover 14, a nose hair trimmer 20, a gear set 30, and a control unit 40. All the cutter blade sets 11, the nose hair trimmer 20, and the control unit 40 are received in a space enclosed by the body case 12, and the front and the rear cover 13, 14. The front cover 13 is internally provided with a guide rail 15 and a passage hole 19.

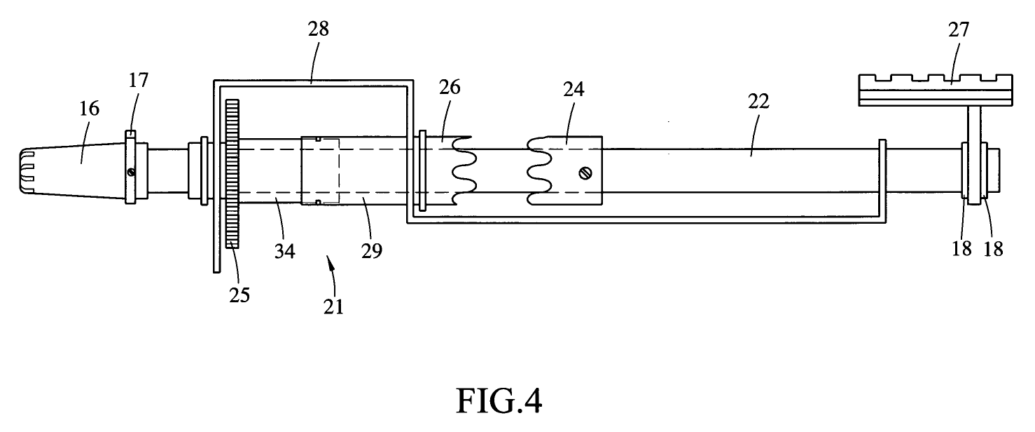

FIG. 4 is a side view of the nose hair trimmer 20. Please refer to FIGS. 3 and 4 at the same time. The nose hair trimmer 20 includes a gear mechanism 21, a central rotary shaft 22, a nose hair blade 23, and an engaging & disengaging element 24. The gear mechanism 21 includes a gear wheel 25, an engaging head 26, and a rack 28. The rack 28 is fixed to a motor 42 for holding the gear wheel 25 and the engaging head 26 in place, and is provided with at least two through holes (not numbered), via which the central rotary shaft 22 is axially extended through the rack 28. The engaging head 26 has a shaft tube 29 axially extended from an end of the engaging head 26 toward the gear wheel 25, and the gear wheel 25 is associated with a tubular section 34, which is corresponding to and extended toward the shaft tube 29. The engaging head 26 has a profile corresponding to that of the engaging & disengaging element 24. The nose hair blade 23 is received in a protective cap 16, at a predetermined position of which a stopper 17 is provided.

The tubular section 24 is sized for fitting in the shaft tube 29 and then fixed thereto with screws, so that the engaging head 26 and the gear wheel 25 are held together to rotate synchronously. The nose hair blade 23 is fixedly mounted to a front end of the central rotary shaft 22 to locate in front of the gear wheel 25. The engaging & disengaging element 24 is mounted on the central rotary shaft 22 to normally locate at a distance behind the engaging head 26.

The central rotary shaft 22 is loosely extended through the through holes on the rack 28, the shaft tube 29, and the tubular section 34, and is adapted to control the engaging & disengaging element 24 to axially slide by a predetermined distance toward or away from the engaging head 26. The central rotary shaft 22 is provided at a rear end with a plurality of retaining rings 18 and a switch key 27. The retaining rings 18 are mounted on the central rotary shaft 22 before and after the switch key 27, such that the switch key 27 is prevented from turning along with the central rotary shaft 22.

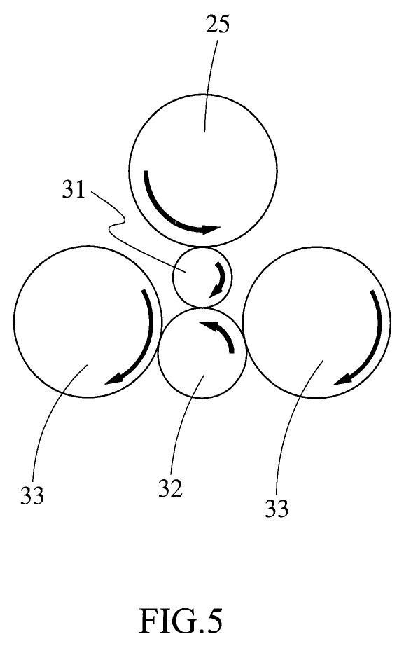

FIG. 5 shows the relative rotational directions of the gear set 30 for the electric shaver 10 and the gear wheel 25 for the nose hair trimmer 20. Please refer to FIGS. 3 and 5 at the same time. The gear set 30 includes a driving gear 31, an idle gear 32, and two driven gears 33. The idle gear 32 meshes with the driving gear 31. The driven gears 33 mesh with the idle gear 32 and are connected to the two cutter blade sets 11. The driving gear 31 also meshes with the gear wheel 25 of the gear mechanism 21 of the nose hair trimmer 20. As can be seen from FIG. 5, the idle gear 32 and the gear wheel 25 rotate in a direction opposite to that of the driving gear 31, while the driven gears 33 rotate in the same direction as the driving gear 31.

As can be seen from FIG. 3, the control unit 40 includes a power supply system 41, such as one or more batteries, and a motor 42 electrically connected to the power supply system 41. The motor 42 is connected to the driving gear 31, so as to drive the gear set 30 to rotate.

When the power supply system 41 is turned on to actuate the motor 42, the motor 42 drives the driving gear 31 to rotate, so that the driving gear 31 further rotates the gear wheel 25 and the idle gear 32, and the idle gear 32 further rotates the driven gears 33 for the cutter blade sets 11 to start shaving a user; meanwhile, the rotating gear wheel 25 brings the engaging head 26 to rotate simultaneously. However, since the gear mechanism 21 is loosely mounted on the central rotary shaft 22, the rotated gear wheel 25 does not cause the central rotary shaft 22 to rotate along with it.

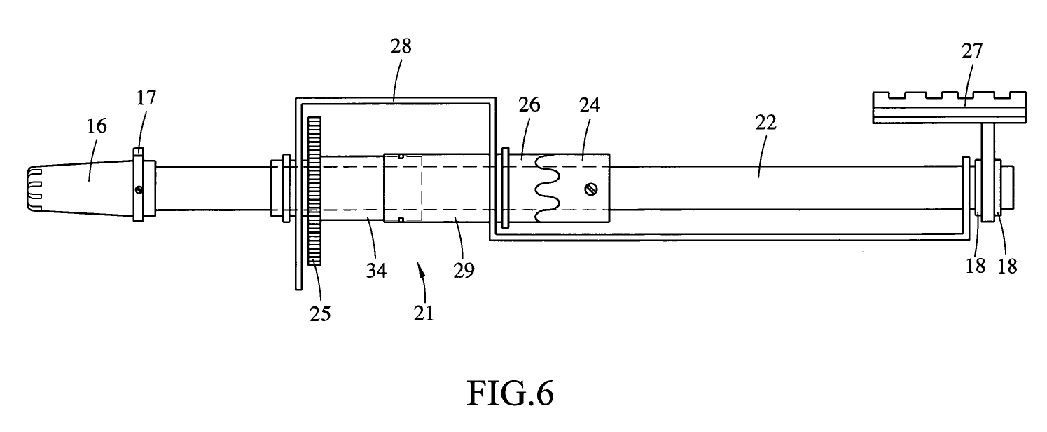

Please refer to FIGS. 2B, 3, and 6 at the same time. When it is desired to trim nose hair, a user needs only to push the switch key 27 to drive the central rotary shaft 22 forward. At this point, the engaging & disengaging element 24 mounted on the central rotary shaft 22 is moved toward and finally engaged with the engaging head 26. The engagement of the engaging & disengaging element 24 and the engaging head 26 brings the central rotary shaft 22 to rotate along with the gear wheel 25. The nose hair blade 23 fixedly mounted to the front end of the central rotary shaft 22 is brought by the forward moved and rotated central rotary shaft 22 to rotate while extending into the protective cap 16, forcing the protective cap 16 to protrude from the front cover 13 via the passage hole 19, so that nose hair trimming may be conveniently conducted. At this point, the stopper 17 provided on the protective cap 16 is confined in the guide rail 15 on the front cover 15, limiting the protective cap 16 to move forward or backward in the passage hole 19 without rotating relative to the front cover 13. When the nose hair blade 23 extends forward and rotates, nose hair stuck in slits formed on the protective cap 16 can be easily cut.

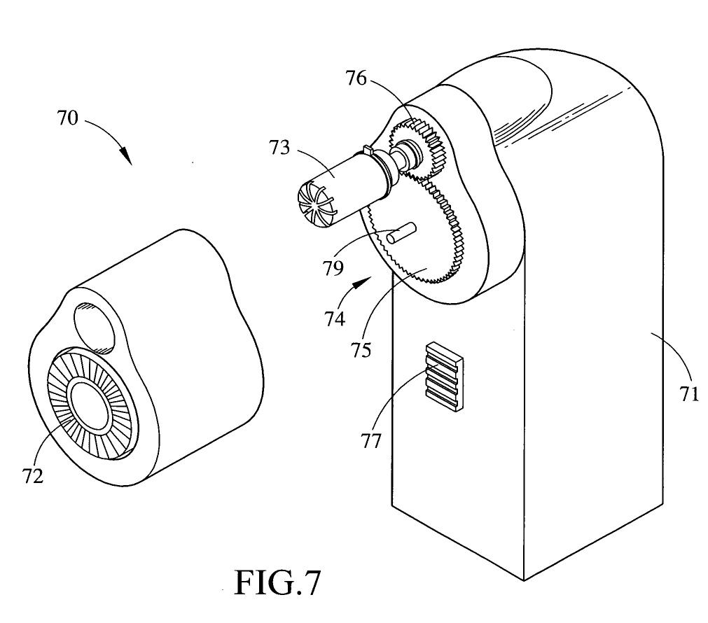

FIG. 7 shows an electric shaver with nose hair trimmer according to a second embodiment of the present invention. The electric shaver in the second embodiment is generally denoted by reference numeral 70, and includes a body case 71, a cutter blade set 72, a nose hair trimmer having a nose hair blade 73, and a gear set 74. The nose hair trimmer in the second embodiment is generally structurally similar to that in the first embodiment. The gear set 74 includes a driving gear 75 and a driven gear 76. When a power supply system (not shown) is turned on to actuate a motor, a rotary shaft 79 of the motor drives the driving gear 75 to rotate, causing the cutter blade set 72 to cut a user's beard. The rotating driving gear 75 brings the driven gear 76 to rotate at the same time. When the driven gear 76 rotates, a user may push a switch key 77 provided on the body case 71, so as to actuate the nose hair blade 73 of the nose hair trimmer, which will then operate to trim the user's nose hair, just as in the first embodiment.

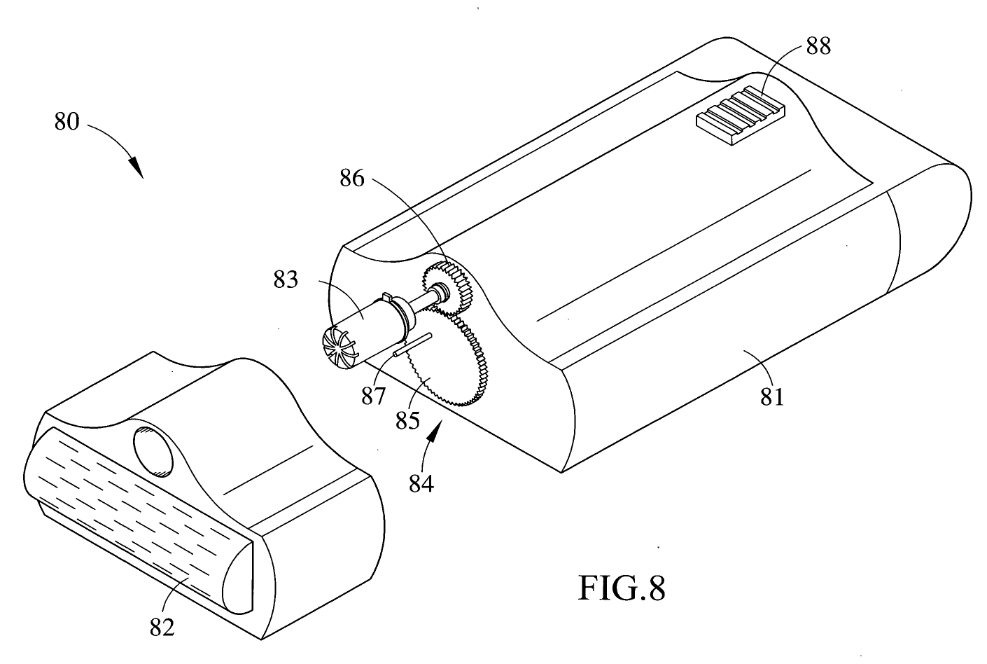

FIG. 8 shows an electric shaver with nose hair trimmer according to a third embodiment of the present invention. The electric shaver in the third embodiment is generally denoted by reference numeral 80, and includes a body case 81, a cutter blade set 82, a nose hair trimmer having a nose hair blade 83, and a gear set 84. The nose hair trimmer in the third embodiment is generally structurally similar to that in the first and the second embodiment. The gear set 84 includes a driving gear 85, a driven gear 86, and a short eccentric shaft 87. When a power supply system (not shown) is turned on to actuate a motor (not shown), the motor drives the driving gear 85 to rotate, so that the short eccentric shaft 87 on the driving gear 85 causes the cutter blade set 82 to generate reciprocating vibration and cut a user's beard trapped in a screen of the cutter blade set 82. The rotating driving gear 85 also brings the driven gear 86 to rotate at the same time. When the driven gear 86 rotates, a user may push a switch key 88 provided on the body case 81, so as to actuate the nose hair blade 83 of the nose hair trimmer, which will then operate to trim the user's nose hair, just as in the first and the second embodiment.

The electric shaver with nose hair trimmer according to the present invention provides two different functions, namely, shaving beard and trimming nose hair. A user needs to manipulate only one device to complete shaving and nose hair trimming in one time. Moreover, the present invention requires only one motor to complete two functions, and can therefore be manufactured at reduced cost to meet general consumers' satisfaction.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An electric shaver with nose hair trimmer, comprising:
a nose hair trimmer including a gear mechanism, a central rotary shaft, a nose hair blade, and an engaging & disengaging element;
the gear mechanism including a gear wheel and an engaging head having a profile corresponding to that of the engaging & disengaging element;
the nose hair blade and the engaging & disengaging element being fixedly mounted on the central rotary shaft, and the engaging & disengaging element being controlled by the central rotary to move a predetermined distance toward or away from the engaging head;
at least one cutter blade set for cutting beard;
a gear set connected with the cutter blade set and meshing with the gear wheel of the nose hair trimmer; and
a control unit connected to the gear set;
whereby when the control unit drives the gear set to rotate, the gear wheel and the engaging head are brought to rotate at the same time; and the central rotary shaft may be moved for the engaging & disengaging element to slide forward and engage with the engaging head, allowing the central rotary shaft and the nose hair blade mounted thereon to rotate to thereby trim nose hair.

2. The electric shaver with nose hair trimmer as claimed in claim 1, wherein the gear set includes a driving gear meshing with the gear wheel, an idle wheel meshing with the driving gear, and two driven gears meshing with the idle gear.

3. The electric shaver with nose hair trimmer as claimed in claim 1, wherein the control unit includes a power supply system and a motor, and the power supply system being electrically connected to the motor while the motor is connected to the gear set.

4. The electric shaver with nose hair trimmer as claimed in claim 1, wherein the nose hair trimmer further includes a rack, to which the gear mechanism is fixedly mounted; and the rack being provided with at least to through holes, via which the central rotary shaft is axially extended.

5. The electric shaver with nose hair trimmer as claimed in claim 2, wherein the driven gears bring the at least one cutter blade set to rotate.
